(19) United States
(12) Patent Application Publication
(10) Pub. No.: US 2008/0219271 A1
(43) Pub. Date: Sep. 11, 2008

(54) IP multicast based systems, apparatuses and methods for TCP connection migration

(75) Inventor: Heikki Ollikainen, Espoo (FI)

Correspondence Address: Hollingsworth & Funk, LLC, Suite 125, 8009 34th Avenue South, Minneapolis, MN, 55425, US

(73) Assignee: Nokia Corporation

(21) Appl. No.: 11/787,940

(22) Filed: Apr. 18, 2007

(30) Foreign Application Priority Data
Apr. 25, 2006 (EP) 06 113 068.8

(51) Int. Cl. H04L 12/28

(52) U.S. Cl. 370/400

(57) ABSTRACT

Systems, apparatuses and methods for changing an address during a session between at least two network nodes is described, wherein at least one network node is able to change its address, comprising associating the session with a network routing entity performing group-based routing, changing the address of at least one of the network nodes, sending a address change request from the at least one network node having changed its address to the network routing entity, and forwarding the address change request to the at least one other network node involved in the session.

### FIELD OF THE INVENTION

The invention relates to a method, a network node and a network routing entity for handling a session upon changing an address of at least one of the network nodes involved in the session.

### BACKGROUND OF THE INVENTION

In the following, an example of a network architecture is described, in which the problem underlying the present application occurs.

Such a network architecture is illustrated in FIG. 1. In particular, it consists of an Access Network and an IP (Internet Protocol) Based Backbone Network. Each Access Network comprises an Access Router, an AAA (Authentication Authorization Accounting) server and a location repository for establishing and maintaining connections to other Access Networks. An Access Network may also comprise Radio Relays for establishing a radio connection to an Access Terminal, for example. The IP based Backbone Network comprises one or more Backbone Routers. The reference characters R1 to R15 define interfaces in the network architecture.

The exemplary network has chosen a TCP (Transmission Control Protocol) based approach as it's mobility solution. Therefore, the base solution for mobility is described in Alex C. Snoeren, Hari Balakrishnan, “An end-to-end approach to host mobility”, MIT laboratory for computer science, Cambridge, MobiCom 2000. This proposal introduces a method how an ongoing TCP connection can change IP address seamlessly using peer-to-peer approach. The TCP connection migration is based on new options—migration-permitted permitted and migration—used in a TCP SYN sequence. This is described in the following briefly, more details can be found from the above document.

Mobility functions are separated over Network Control, IP Routing, IP forwarding and access link layers in our example. This is illustrated in FIG. 2. In particular, this figure shows different layers in the network. In the service layer, entities such as Domain Name Servers (DNS) or Realm Aware Source Routing (RASR) are provided. The network control layer is arranged below the service layer and is access independent. On this layer, Interstitial Functions (IF) are provided. The global mobility layer (L3, i.e., IP layer) is arranged below the network control layer and is also access independent. On this layer, Access Routers (AR) are provided. The lowest layer, below the global mobility layer, the local mobility layer (L2) is arranged, which provides access link mobility. On this layer, Access Points (AP), the cells and user entities (UE) are arranged. Moreover, between the global mobility layer and the local mobility layer, L2 switching functions are provided.

Thus, mobility in a network constructed along these guidelines may occur in a global and in a local scope:

Global mobility is handled on IP (L3) and transport (L4) layer where reachability is based on Realm Aware Source Routing (RASR) system and the use of new DNS record(s) i.e. UA record. Global Mobility is based on functions provided by IP, transport and network control Layer e.g. Interstitial Function (IF). RASR and UA records are for further study (FFS), therefore both of them are out of the scope of this application.

Local mobility is handled with L2 switching in order to support fast and seamless intra-access (L2) handovers. Therefore, access link layer mobility is fully transparent to upper layers.

The network IP backbone (or Operator's IP backbone) represents the global mobility layer that is interconnected to other service provider's or operator's IP backbones. Furthermore, in this example it is also connected to the public Internet. Above the actual IP access network layer there can be formed service layers that provide different services depending on configuration (or business model).

Existing TCP connections are retained using secure and efficient connection migration, since the TCP connection is uniquely identified by 4-tuple—source port, destination port, source IP address and destination IP address. An end-to-end TCP connection migration approach as described above enables established TCP connections to seamlessly negotiate a change in endpoint IP addresses without the need for third party.

FIG. 3 presents a sample TCP connection establishment using extended TCP functionality. In this example, a User Equipment (UE) connects to a fixed node and then changes (FIG. 4) an IP address. The following functionality and steps take place for TCP connection migration:

Step S1: UE initiates a TCP connection including the TCP migration permitted-option (MigrateOK) in the SYN segment. The values Km and Tm are parameters that are used in the token negotiation. The SYN segment or message contains a sequence number (531521 in this example).

Step S2: The fixed node indicates its capability for migration by including the migration-permitted option into its response.

Step S3: The UE completes the 3-way handshake with an acknowledgement. Then the TCP connection proceeds as any TCP connection.

Step S4: Migrate TCP connection then proceeds as any TCP connection would until step S4, when the last packet from the fixed node to UE is at its current address. The fixed node completes the connection by acknowledgement.

After a while (FIG. 4), it is assumed that the UE changes its IP address, the following TCP connection migration procedure takes place:

Step S5: The UE notifies the fixed node by sending a SYN segment from its new address. This SYN segment includes the migration option that contains the previously counted token T as part of migration request. The sequence number of this migrate SYN segment is the same as the last byte of transmitted data (092397 in this example). R is a request, which is also a number.

Step S6: The fixed node responds using sequence number of its last transmitted byte of data (545967 in this example).

Step S7: The acknowledgement is from the same sequence space as the previous connection. However, it might be the case that the segments were lost during a period of disconnection (e.g. 2-4 seconds) while mobile is moving.

The problem that TCP connection migration approach suffers is that it does not support the mobility especially too well from P2P (peer-to-peer) point of view. The TCP connection migration was chosen to the presented mobility solution because it is fully transparent to the application level, provides P2P based security features, and other hosts are not forced to use it, if they don't have the TCP connection migration capability, normal TCP communications can be used as well. Deployment of this kind of approach could be also easier, if the deployment does not require big changes to existing infrastructure. Furthermore, TCP connection migration may work poorly for example in the case where mobile node is moving very fast e.g. end-user in the car. In this case, the TCP connection migration will be too slow too to maintain ongoing communications if the networks and IP addresses changes too quickly. On the other hand, it should be notified that this also depends on the size of networks and the area where access routers (AR) are expected to reside and possible IP address changes to occur.

A main problem which occurs in this scenario is a simultaneous movement—the so-called “double jump” problem, where both TCP communicating end-points change their IP address exactly or basically at the same time. If both communicating TCP end-points change their IP address at the same time, the connection migration request does not reach the other end-point since it has moved to a new IP address, and vice versa. Neither of the TCP communicating end-points has any knowledge of the new IP address, so the TCP connection migration is unable to occur and the TCP session will be lost.

It is noted that in the past, the “double jump” case has not been considered as very important since IP addresses are changed relatively infrequently. However, due to recent developments of multi-access terminals which may roam across different radio access technologies (inter RAT handovers, or hard handovers) and increased terminal mobility in general, migrations may occur more often, so that the problem regarding the “double jump” case will may become more important.

### SUMMARY OF THE INVENTION

Thus, one aspect of the invention involves improving the reliability of maintaining a session in case of an address change of one or more network nodes involved in the session, in particular in case both network nodes involved in this session change their addresses.

According to an aspect of the present invention, a method for changing an address during a session between at least two network nodes is provided, where at least one network node is able to change its address. Such a method includes associating the session with a network routing entity performing group-based routing, and changing the address of at least one of the network nodes. The network routing entity receives an address change request from the at least one network node having changed its address. The address change request is forwarded to the at least one other network node involved in the session.

Alternatively, according to another aspect, there is provided a method for changing an address of a first network node during a session with a second network node. Such a method includes associating the session with a network routing entity performing group-based routing, by the first network node. The representative method further involves changing the address of the first network node, and sending an address change request from the first network node to the network routing entity.

According to a further aspect of the invention, there is provided a method for changing an address of a first network node during a session with a second network node. Such a method includes associating the session with a network routing entity performing group-based routing, by the second network node, and receiving an address change request of the first network node from the network routing entity.

According to a further aspect of the present invention, there is provided a device that includes a controller configured to conduct a session with a network node, associate the session with a network routing entity performing group-based routing, and change an address of the device. The device also includes a transmitter configured to send an address change request the network routing entity.

According to a further aspect of the present invention, a device is provided that includes a controller configured to conduct a session with a network node and associate the session with a network routing entity performing group-based routing. The device also includes a transmitter configured to receive an address change request of the network node from the network routing entity.

The devices described above may be integrated in a network node.

According to a further aspect of the present invention, there is provided a device including a controller configured to maintain a group and to receive and forward information to and from network nodes belonging to a group. The device includes a receiver for receiving an address change request from at least one network node having changed its address, and a transmitter for forwarding the address change request to an at least one other network node involved in the session.

The device described above may be integrated in a network routing entity performing group-based routing.

Thus, according to the aspects of the invention as described above, the session is associated to a network routing entity, so that the two network nodes involved join a group. In this way, they can inform each other of an address change by using the network routing entity, so that the changed addresses can reliably be informed to the other network node. Hence, the connection can be maintained.

In the following, some further advantageous developments of the above aspects are described:

The session may be carried out using a packet protocol (e.g., an end-to-end packet protocol).

The session may be associated with the network routing entity by joining a group, wherein an address of the group remains unchanged.

The address change request may be a migration request.

In the address change request, the new address of the network node having changed its address may be informed.

An address change may be initiated by sending an indication from the network node which is about to change its address to the at least one other network node involved in the session that an address change is allowed.

Furthermore, at least two of the network nodes involved in the session may be able to change their addresses, and in case of an address change of the at least two network nodes, sending and forwarding of the address change requests of the at least two network nodes may be performed simultaneously.

Additionally, according to the present invention, a computer program product is presented, comprising processor implementable instructions for performing the steps of the method according to any one of the above method aspects.

In particular, the computer program product may comprise a computer-readable medium on which the software code portions are stored; and/or the computer program product is directly loadable into an internal memory of the network element.

### BRIEF DESCRIPTION OF THE DRAWINGS

The invention is described by referring to the enclosed drawings, in which:

FIG. 1 shows an illustrative network architecture,

FIG. 2 shows an illustration of network-level mobility,

FIG. 3 shows a TCP connection establishment using migrate options,

FIG. 4 shows a TCP connection migration,

FIG. 5 shows a TCP migration using IP multicasting for connection migration request exchange according to an embodiment of the present invention,

FIG. 6 shows a procedure for exchanging TCP connection migration request(s) using IP multicast according to the embodiment of the invention,

FIG. 7 shows an initial TCP connection establishment when migrate-option (and IP multicasting) are used according to the embodiment of the present invention,

FIG. 8 shows a TCP migration signaling in the case of a “double jump” according to the embodiment of the present invention,

FIG. 9A shows an example for a first user entity according to the embodiment of the present invention,

FIG. 9B shows an example for a second user entity according to the embodiment of the present invention, and

FIG. 9C shows an example for a multicast router according to the embodiment of the present invention.

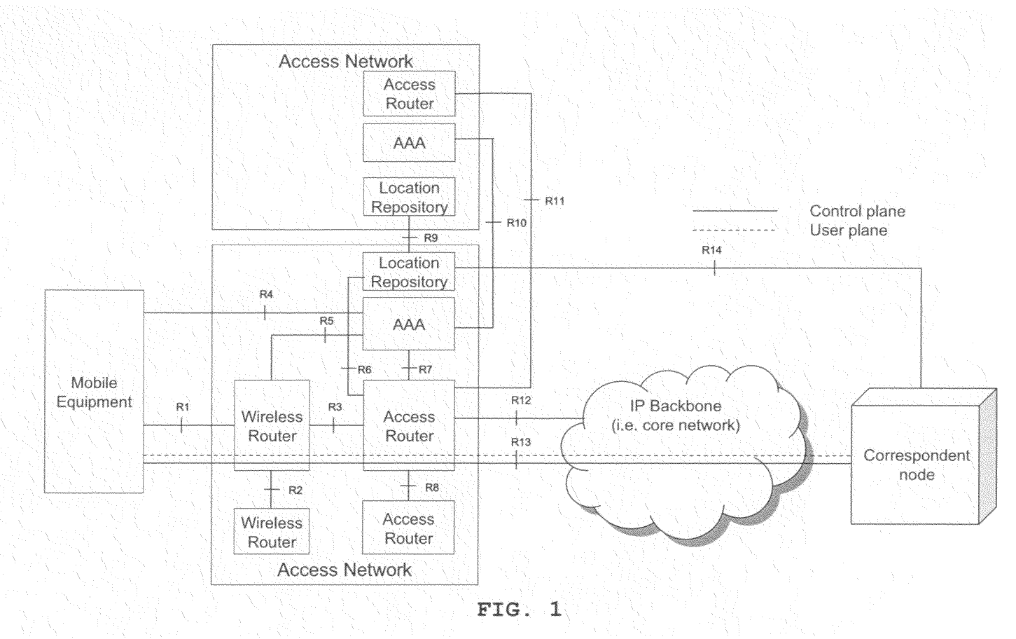

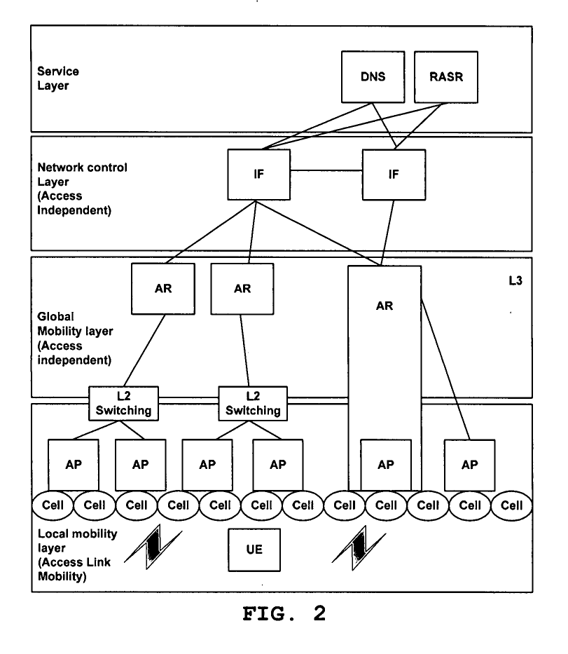

### DETAILED DESCRIPTION OF EMBODIMENTS OF THE INVENTION

In the following, embodiments of the present invention are described by referring to the attached drawings.

According to one embodiment, a procedure is described by which communicating TCP (Transport Control Protocol) end-points can receive TCP connection migration request(s) in particular in the case of “double jump” (simultaneous movement of at least two network nodes involved in a session).

In detail, a procedure is described in which IP (Internet Protocol) multicast communication is used for exchanging the TCP connection migration requests. According to the present embodiment, both communicating end-points join to a multicast group during the migrated TCP session establishment. The signaling of TCP connection migration is the same as before, but the connection migration request(s) is/are sent to multicast group/address instead of the unicast IP address of the correspondent end-point. If there is a short disconnection during the IP address change, both communicating TCP end-points join automatically to the multicast group (as soon as network interface has new IP address and the connectivity), and send the TCP connection migration request.

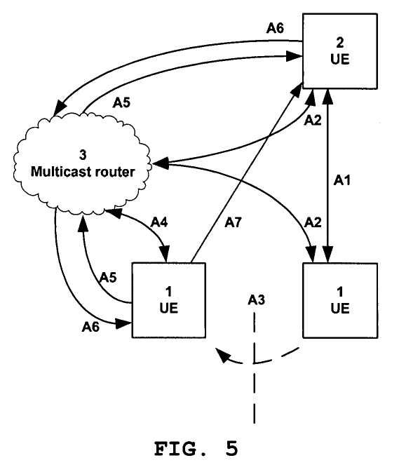

First, FIG. 5 describes the case where mobile terminal and fixed node are in migrated TCP communication, and then mobile terminal changes its IP address. This case is described using the proposed multicast group for exchanging the TCP migration request.

In FIG. 5, a first user entity (UE) 1 (as an example for a first network node), a second user entity (UE) 2 (as an example for a second network node) and a Multicast router 3 (as an example for a network routing entity performing a group-based routing) is shown. The first UE 1 is able to change its address. Moreover, in the example of FIG. 5, the second UE 2 is shown as fixed node. However, this does not imply that the second UE 2 is not mobile. By contrast, also the second UE 2 may be mobile and be able to change its address. However, in the following description it is assumed that the second UE 2 maintains its address, thus, it is also referred to as the fixed node. Nevertheless, the second UE 2 may also be a non-mobile node.

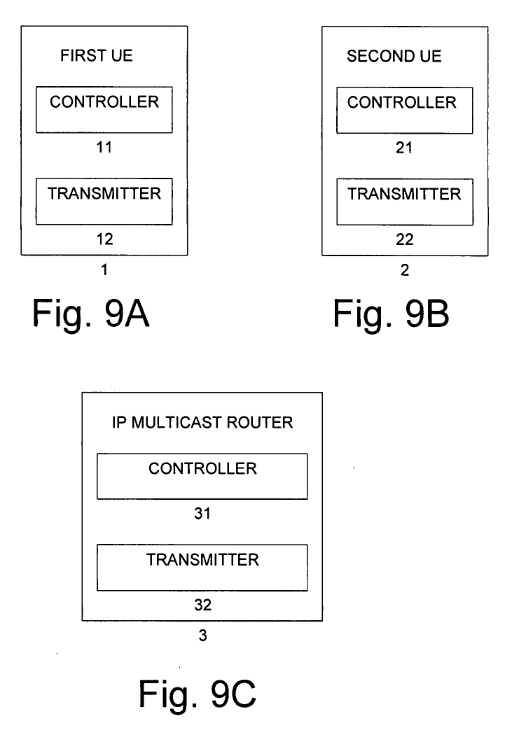

FIGS. 9A to 9C show the different elements involved in some more detail.

FIG. 9A shows an example for the first UE 1 which comprises a controller 11 and a transmitter 12. FIG. 9B shows an example for the second UE 2 which comprises a controller 21 and a transmitter 22. The principle structure of both UEs is similar. The controller 11 (21) is configured to carry out the functionality described in the following with respect to the side of the first UE 1 and the second UE 2, respectively. The controller may comprise a computer which includes a processor, a memory, interfaces and the like. The transmitter 12 (22) is configured to send and receive information. This may be effected by using cellular radio communication or WLAN or other wireless technology, however, this is not limited thereon. It is noted that different network access types may be supported. Moreover, the transmitter may support a fixed connection. In the example of FIG. 5, the UE 2 is a fixed node which may have only a wired connection.

FIG. 9C shows an example for the IP multicast router 3, which comprises a controller 31 and a transmitter 32. Similar as described in connection with the UEs, the controller 31 is configured to carry out the functionality described in the following with respect to the side of the multicast router. The controller may comprise a computer which includes a processor, a memory, interfaces and the like. The transmitter 32 is configured to send and receive information. Similar as described above in connection with the UEs, different network access types may be supported.

The IP multicast router performs group-based routing, wherein the address of the group remains unchanged. In order to receive information the members of the group (i.e., the network nodes such as UE 1 and UE 2) join the group. When member sends information to the group address, the other member can listen in order to receive the information.

In the following, functional steps are described:

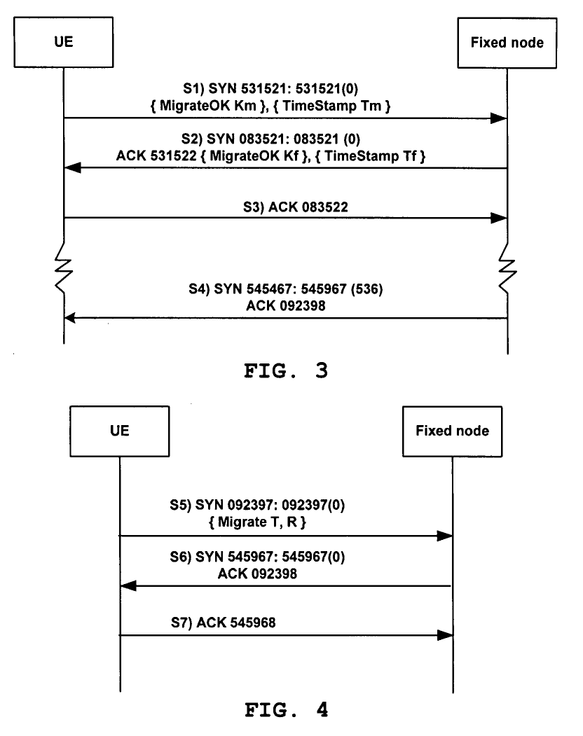

In step A1, migration TCP session establishment signaling is exchanged. In particular, this signaling is as described in FIG. 3. This signaling is initiated by the UE 1 which is about to change its address.

In step A2, both end-points (i.e., UE 2 (fixed node) and UE 1) join to multicast group. That is, they sent corresponding signaling to the multicastrouter.

In step A3, UE 1 moves to an area where IP address change occurs. Brief disconnect may be experienced.

In step A4, the UE 1 joins back to the multicast group, after it has a new IP address in the network interface. It is noted that in this particular case, the old functionality where the migration request is sent straight to unicast address of fixed node (i.e., UE 2), would also work. However, as mentioned above, the use of the multicast group is presented since there might be the “double jump” case, and because of this a multicast address for the UE 1 is provided where it can send the TCP connection migration request. This example shows that the procedure according to the present embodiment also works in case when only one of the network nodes involved in the TCP session changes its address.

In step A5, the UE 1 sends a migration request to multicast group. This migration request starts the sequence presented in FIG. 4. Since the fixed node (UE 2) belongs to multicast group, it is able to receive the migration request, and is able to provide an acknowledgement as a response.

The UE 1 keeps sending the migration request(s) (step A5) as long as it will receive the acknowledgement from the UE 2 (via the multicast router). Otherwise the signaling follows the same procedure as presented in FIG. 4.

In step A6, when the destination fixed node (UE 2) receives the migration request, it responds to it with acknowledgement using multicast group.

In step A7, when the UE 1 has received an acknowledgement and learned the fixed node's new unicast IP address, they can continue the ongoing TCP session (P2P).

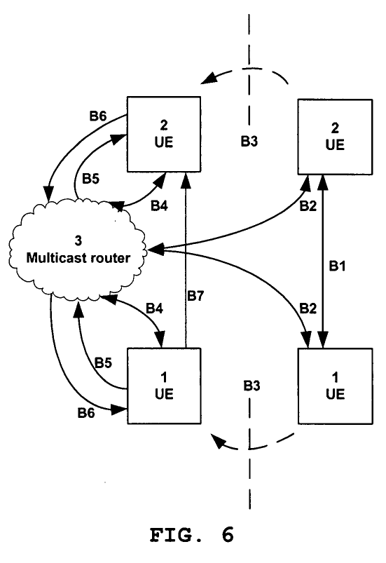

In the following, a procedure is described which takes place in case of the exceptional case of a exception case “double jump”, i.e., when both network nodes involved in the session change their address at the same time (or basically the same time), by referring to FIG. 6. In this connection, it is noted that the “same time” or “simultaneous” as used in the present description of the embodiment does not necessarily mean the exact same point in time. Namely, as mentioned above, after the TCP migrate, it may take up to some seconds until the new address of the network node changing its address is fixed. Thus, the “double jump” problem may also occur when the second UE changes its address one or two seconds after the first UE changes its address. Namely, at this point in time, the second UE is not yet aware of the address change of the first UE. Thus, “basically the same time” means that the two address changes may occur within a time period which may last for about several seconds.

It is noted that FIG. 6 basically corresponds to FIG. 5, with the exception that now also the UE 2 may change its address (i.e., is not a fixed node with a fixed address).

In detail, the following functional steps are carried out:

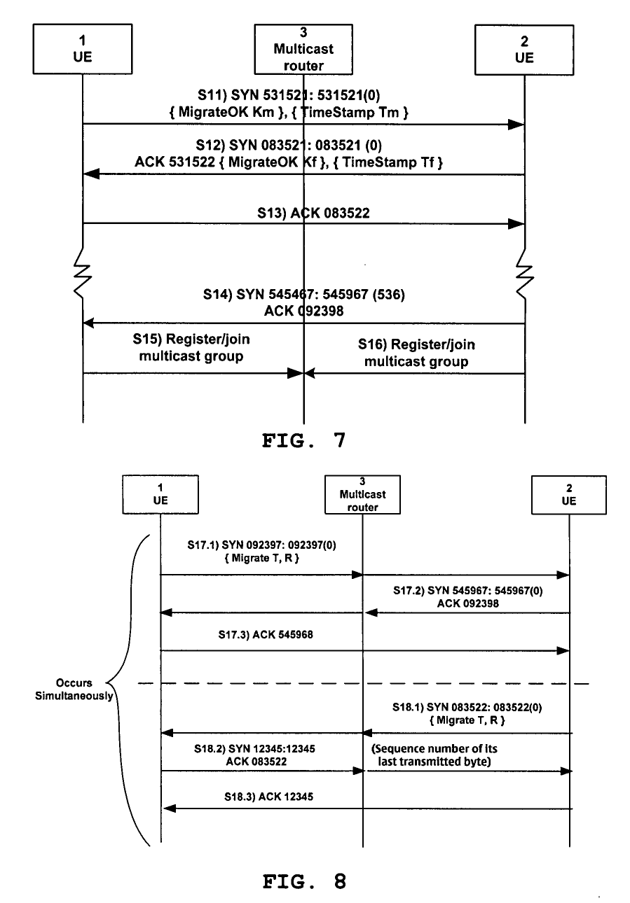

In step B1, a migration TCP session establishment signaling as described in FIG. 7 described later is carried out.

In step B2, both UEs join a multicast group by sending corresponding signaling to the multicast router 3. It is noted that the multicast group will be used also to message exchange in migration case, when only the other end-point changes its address (as described above in connection with FIG. 5). As mentioned above, this “double jump” case is an exception.

In step B3, both UEs move to area where IP address change occurs. Brief disconnect is experienced.

In step B4, when both UEs have new IP address in the network interface, they join back to multicast group, by sending corresponding signaling to the multicast router 3.

It is noted that in “single jump” case, when only one of the UEs involved in the session changes its IP address, this triggers the UE to send migration request, and the request reaches the destination without problem. Now, when both UEs change IP addresses, each of the UEs (1 and 2) needs an IP address (multicast group's IP address) to which it can send the migration request. If the UE (1 or 2) would send the migration request to old IP address of the correspondent UE, it won't be there anymore and the migration request would be lost. This would result in a breakdown of the ongoing session. Thus, the procedure according to the present embodiment is carried out.

In step B5, both UEs 1 and 2 send a migration request to the multicast group. This migration request starts the sequence presented in FIG. 8 described later. Since both UEs are joined into the multicast group, they are able to receive the migration request. Both UEs 1 and 2 keep sending the migration request (step B5) as long as the acknowledgement is received from the multicast group. This because it may take few seconds before the network interface is ready for communication (after receiving the new IP address to it).

In step B6, when destination UE (UE 2 in the example of FIG. 6) receives the migration request, it responds to it with acknowledgement to multicast group's IP address.

In step B7, when each of the UEs has received an acknowledgement and learned the correspondent node's new unicast IP address, they can continue the ongoing TCP session (P2P).

In the following, the sequence shown in FIG. 7 is described in more detail. This sequence is triggered in step B1 of FIG. 6.

In step S11, the UE 1 initiates a TCP connection including the TCP migration permitted-option (MigrateOK) in the SYN segment. As described in connection with FIG. 3, the values Km and Tm are parameters that are used in the token negotiation. The SYN segment or message contains a sequence number (531521 in this example).

In step S12, at the same time or almost the same time as the UE 1, the UE 2 initiates a TCP connection including the TCP migration permitted-option (MigrateOK) in the SYN segment. The values Kf and Tf correspond to the parameters Km and Tm described above. The SYN segment or message contains a sequence number (083521 in this example).

In step S13, the UE 1 sends an acknowledgement ACK including the incremented sequence number received in step S12 from the UE 2. After this, the TCP connection may proceed normally. In this example, 536 packets may be sent, until the next step S14 is reached.

In step S14, the UE 2 sends a SYN message including the current sequence number (545967 in this example) of the UE 2 to the UE 1. The UE 2 completes the connection by acknowledgement ACK including the sequence number of the UE 1 (092398 in this example).

In step S15, the UE 1 registers/joins the multicast group (corresponding to step B2 of FIG. 6).

In step S16, also the UE 2 registers/joins the multicast group (corresponding to step B2 of FIG. 6).

FIG. 8 shows a TCP migration signaling in the case of a “double jump” according to the embodiment of the present invention. This is triggered by the step B5 of FIG. 6.

In particular, it is now assumed that both UEs have changed their IP addresses. In step S17.1, the UE 1 notifies multicast router by sending a SYN segment from its new address. It is noted that this is sent to the group address. This SYN segment includes the migration option that contains the previously counted token T as part of migration request, as also described in connection with FIG. 4. The multicast router forwards the SYN segment to the UE 2.

In step S17.2, the UE 2 responds using the sequence number of its last transmitted byte of data (545967 in this example), and also sends an acknowledgement ACK. This is sent via the multicast router, i.e., again by using the group address.

In step S17.3, the UE 1 sends an acknowledgement to the UE 2. It is noted that this acknowledgement is not sent via the multicast router, but via peer-to-peer (P2P).

The steps S18.1 to S18.3 correspond to the steps S17.1 to S17.3, with the exception that in this case the UE 2 starts the sequence.

It is noted that the steps S17.1 to S17.3 on the one hand and the steps S18.1 to S18.3 on the other hand occur simultaneously. That is, both UEs try to re-establish the TCP connection simultaneously.

Thus, according to the embodiment described above, a TCP session is associated with an IP multicast router. This router can facilitate the more frequent “single jump” migrations where only one endpoint changes its address (as described above in connection with FIG. 5), but more importantly it can also forward the new IP addresses of the endpoints in the “double jump” case (as described above in connection with FIG. 6). The endpoints report their new (and old) addresses to the IP multicast router, which then forwards them to the appropriate recipients and the TCP session can continue uninterrupted.

It is noted that the solution according to the embodiment of the present invention works with existing DNS architecture and is compatible with TCP/IP migrate. Hence, the solution according to the present embodiment can be easily implemented.

It is noted that migrate TCP works also with TCP hosts that do not have the migrate capability. In this case, normal TCP communication takes place. Thus, the present embodiment can also be implemented in a network in which not all nodes have the functionality according to the present embodiment.

Moreover, the present embodiment presents a peer-to-peer solution and can use existing network infrastructure, multicast routers and DNS. For carrying out the embodiment, only the multicast routers (or similar elements) would have to be modified according to the embodiment. That is, no additional dedicated network control elements are required.

Thus, the embodiment extends an existing functionality, so that no new functionality from the network point of view is necessary, only a configuration of existing systems.

The invention is not limited to the embodiment described above, and various modifications are possible.

For example, the invention is not limited to specific protocols described above. That is, also other end-to-end packet protocols may be used instead of TCP and IP/TCP, in which each of the endpoints is identified by an address.

Furthermore, according to the embodiment, an IP multicast router is described. However, this is only an example for a network routing entity. This entity can be any kind of an entity that performs a group-based routing, such that an address of a group remains unchanged.

In the embodiment, a TCP session between two endpoints (UE 1 and UE 2) was described. However, the procedure is also applicable for a plurality of endpoints, e.g., in a group call or the like.

The methods according to the present embodiment can be implemented as computer programs. This may be loaded in computers or controllers controlling the different network nodes involved, e.g., the UE 1, the UE2 and the multicast router. That is, the computer program may be embodied on a computer-readable medium and the computer program may be directly loadable into the memory of the computer, so that a processor of the corresponding controller (computer) may carry out the instructions of the program.

What is claimed is:

1. A method, comprising:
associating at least two network nodes involved in a session at a network routing entity performing group-based routing, wherein at least one network node is able to change its address;
receiving an address change request from at least one network node having changed its address at the network routing entity; and
forwarding the address change request to the at least one other network node involved in the session.

2. The method according to claim 1, wherein associating the nodes at the network routing entity is performed by joining a group, wherein an address of the group remains unchanged.

3. The method according to claim 1, wherein the address change request is a migration request.

4. The method according to claim 1, further comprising initiating an address change by sending an indication from the network node which is about to change its address to the at least one other network node involved in the session that an address change is allowed.

5. The method according to claim 1, wherein at least two of the network nodes involved in the session are able to change their addresses, and in case of an address change of the at least two network nodes, sending and forwarding of the address change requests of the at least two network nodes are performed essentially simultaneously.

6. A method comprising:
associating a session involving at least a first network node and a second network node with a network routing entity performing group-based routing, by the first network node;
changing the address of the first network node; and
sending an address change request from the first network node to the network routing entity.

7. The method according to claim 6, wherein associating the session with the network routing entity is performed by joining a group, wherein an address of the group remains unchanged.

8. The method according to claim 6, wherein the address change request is a migration request.

9. A method comprising:
associating a session involving at least a first network node and a second network node with a network routing entity performing group-based routing, by the second network node wherein the first network node is able to change its address; and
receiving an address change request of the first network node from the network routing entity.

10. The method according to claim 9, wherein associating the session with the network routing entity is performed by joining a group, wherein an address of the group remains unchanged.

11. The method according to claim 9, wherein the address change request is a migration request.

12. A device comprising:
a controller which is configured
to conduct a session with a network node, to associate the session with a network routing entity performing group-based routing, and
to change an address of the device; and
a transmitter which is configured to send an address change request the network routing entity.

13. The device according to claim 12, wherein the controller is adapted to join a group maintained by the network routing entity in order to associate the session with the network routing entity, wherein an address of the group remains unchanged.

14. The device according to claim 12, wherein the address change request is a migration request.

15. The device according to claim 12, wherein the controller is adapted to initiate an address change by sending an indication from the network node to the at least one other network node involved in the session that an address change is allowed.

16. The device according to claim 12, further comprising a receiver which is configured to receive an address change request from at least one other network node involved in the session.

17. A device comprising:
a controller which is configured
to conduct a session with a network node, and
to associate the session with a network routing entity performing group-based routing; and
a receiver which is configured to receive an address change request of the network node from the network routing entity.

18. The device according to claim 17, wherein the controller is adapted to join a group maintained by the network routing entity in order to associate the session with the network routing entity, wherein an address of the group remains unchanged.

19. The device according to claim 17, wherein the address change request is a migration request.

20. The device according to claim 17, wherein the controller is configured to change the address of the device.

21. The device according to claim 17, further comprising a transmitter which is configured to send an address change request the network routing entity.

22. A computer program product embodied on a computer-readable medium for a computer, comprising software code portions for performing associating a the session involving at least two network nodes with a network routing entity performing group-based routing, wherein at least one network node is able to change its address;
changing the address of at least one of the network nodes;
sending an address change request from the at least one network node having changed its address to the network routing entity; and
forwarding the address change request to the at least one other network node involved in the session.

23. The computer program product according to claim 22, wherein the computer program product is directly loadable into an internal memory of the computer.

24. The computer program product according to claim 22, wherein the computer is incorporated in a controller of a network node.

25. The computer program product according to claim 22, wherein the computer is incorporated in a network routing entity performing group-based routing.

26. A computer program product embodied on a computer-readable medium for a computer, comprising software code portions for performing
associating the session involving at least a first network node and a second network node with a network routing entity performing group-based routing, by the first network node;
changing the address of the first network node; and
sending an address change request from the first network node to the network routing entity.

27. The computer program product according to claim 26, wherein the computer program product is directly loadable into an internal memory of the computer.

28. The computer program product according to claim 26, wherein the computer is incorporated in a controller of a network node.

29. A computer program product a computer-readable medium for a computer, comprising software code portions for performing
associating a session involving at least a first network node and a second network node with a network routing entity performing group-based routing, by the second network node wherein the first network node is able to change its address; and
receiving an address change request of the first network node from the network routing entity.

30. The computer program product according to claim 29, wherein the computer program product is directly loadable into an internal memory of the computer.

31. The computer program product according to claim 29, wherein the computer is incorporated in a controller of a network node.

32. A device comprising:
means for conducting a session with a network node,
means for associating the session with a network routing entity performing group-based routing,
means for changing an address of the device; and
means for sending an address change request the network routing entity.

33. A device comprising:
means for conducting a session with a network node, and
means for associating the session with a network routing entity performing group-based routing; and
means for receive an address change request of the network node from the network routing entity.
